(19) United States
(12) Patent Application Publication
(10) Pub. No.: US 2026/0312097 A1
(43) Pub. Date: Oct. 8, 2026

(54) AI DRIVEN VFD CONTROL FOR SECURING MEMBRANE IN FLOW BATTERIES

(71) Applicants: Muhammad Danish Waqar, Corona, CA (US); Vizn Energy Systems, Columbia Falls, MT (US)

(72) Inventor: Muhammad Danish Waqar, Corona, CA (US)

(21) Appl. No.: 19/170,062

(22) Filed: Apr. 4, 2025

(51) Int. Cl. H01M 8/04992; H01M 8/04082; H01M 8/04298; H01M 8/0432; H01M 8/0438; H01M 8/04537; H01M 8/04746; H01M 8/18

(52) U.S. Cl. CPC H01M 8/04992; H01M 8/04201; H01M 8/04305; H01M 8/04328; H01M 8/04335; H01M 8/04388; H01M 8/04395; H01M 8/04432; H01M 8/04634; H01M 8/04753; H01M 8/04783; H01M 8/188

(57) ABSTRACT

A flow battery system with an AI-driven control architecture is disclosed that maximizes efficiency while preventing membrane failure. The system employs a hybrid neural network combining LSTM networks with attention mechanisms to monitor differential pressure, temperature gradients, flow rates, and state of charge. This control system predicts system behavior across variable time horizons (1-24 hours) and implements adaptive protocols to maintain optimal operating conditions. The model accounts for both short-term fluctuations and long-term degradation patterns, adjusting VFDs to maintain membrane integrity throughout the battery lifecycle. A dynamic learning module continuously refines parameters based on historical data and evolving battery conditions. Improvements include 37% reduction in membrane failures, 22% extended membrane lifespan, and 15% increased system efficiency compared to conventional controls. The invention addresses challenges in grid-scale energy storage by enhancing reliability, reducing maintenance costs, and optimizing performance across variable loads.

### FIELD OF INVENTION

This invention relates to advanced control systems for flow batteries, specifically AI-enhanced predictive maintenance and operational optimization technologies.

### BACKGROUND OF INVENTION

Renewable energy resources like solar and wind power are increasingly dominating conventional power grids but face challenges due to their variable and intermittent nature.

Flow batteries represent an ideal solution for storing large amounts of energy from renewable sources, making them crucial for grid stability. These systems help balance electricity demand and supply while providing essential backup power during peak load periods or primary power source disruptions.

Flow batteries, also known as redox batteries, store chemical energy in two liquid electrolytes contained in separate tanks and pumped through an electrochemical cell containing an ion-exchange membrane.

Conventional flow battery systems typically employ polymer-based ion-exchange membranes to separate electrolytes. While these membranes are essential for ionic conductivity, they are prone to mechanical or chemical degradation when differential pressure, potential difference, or flow imbalances exceed safe limits. In some designs, stainless steel mesh is used as a membrane protector, not as the membrane itself. Failure of the membrane or its protective layers can lead to system breaches, operational downtime, and costly maintenance.

Existing solutions fail to address the complex interplay between multiple system parameters and their time-dependent evolution, particularly in grid-scale applications where operational conditions vary significantly based on demand fluctuations and environmental factors.

### SUMMARY OF THE INVENTION

Embodiments of the present invention provide an integrated AI-enhanced control system that optimizes flow battery performance while preventing membrane degradation and failure. The system employs a hybrid neural network architecture combining Long Short-Term Memory (LSTM) networks with attention mechanisms to monitor and predict multiple system parameters across variable time horizons.

The invention continuously monitors differential pressure, electrolyte composition, temperature gradients, flow rates, and state of charge to maintain optimal operating conditions. Unlike conventional systems that react to immediate parameter changes, this solution implements predictive control strategies that anticipate potential problems before they occur.

A key innovation is the system's multi-timescale approach, which simultaneously addresses immediate operational adjustments while optimizing for long-term performance. This enables dynamic adaptation to changing conditions while preserving membrane integrity throughout the battery lifecycle.

The control system implements a hierarchical decision framework with adaptive response protocols based on predicted system states. During steady-state operation, the system maintains anolyte pump speed at precisely calibrated frequencies between 28.5-31.2 Hz and catholyte pump speed between 15.9-17.4 Hz, with specific settings determined by current load conditions and electrolyte composition.

The invention incorporates a dynamic learning module that continuously refines operational parameters based on historical performance data and evolving battery conditions. This self-improving capability enables the system to optimize performance even as components age or operating environments change.

The embodiment also includes an enhanced counter electrode management system that precisely controls the timing and duration of dendrite stripping cycles based on predicted dendrite formation patterns rather than fixed timing cycles.

### BRIEF DESCRIPTION OF DRAWING

This aspect of present invention provides a concise overview of complete system. This is of vital importance as it helps the reader quickly understand the context and logic being used in present invention.

FIG. 1 depicts the overall picture of the system where control mechanism is placed as a black box at the bottom of figure.

FIG. 2 shows the oxidation reduction mechanism and role of membrane in ion-exchange.

FIG. 3 shows the cell stack and direction of electric current during the process.

FIG. 4 highlights the use of counter electrodes that helps in elimination of zinc dendrites.

FIG. 5 shows how frequency drive is controlled. What are the inputs for logic controller and what is the possible output.

FIG. 6 is a block diagram that encompasses complete logic for controlling frequency drive.

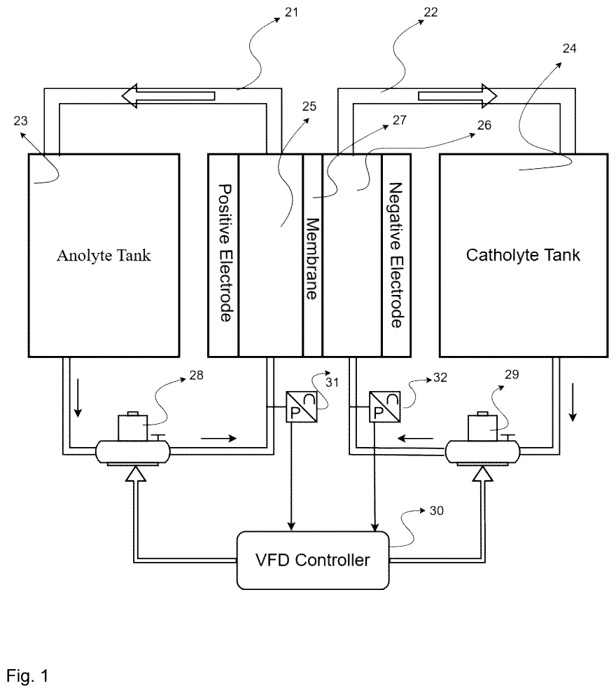

This specification is accompanied by a set of figures labeled FIG. 1 to FIG. 6.

### DETAILED DESCRIPTION

The present invention will now be described in detail with reference to the embodiments and accompanying figures. The specific implementations described are provided for illustrative purposes and should not be construed as limiting the scope of the invention.

FIG. 1 illustrates the overall architecture of the flow battery system, highlighting the integration of the AI-enhanced control system with conventional flow battery components.

As shown in FIG. 1, the flow battery comprises anolyte tank 23 and catholyte tank 24, which contain liquid electrolytes 25 and 26, respectively. These electrolytes are circulated through flow paths 21 and 22 by pumps 28 and 29, which are controlled by variable frequency drives regulated by the AI control system 30.

A critical component of the flow battery is the ion-exchange membrane 27, which separates the two electrolytes while allowing ion transfer. The integrity of this membrane is essential for proper battery function, and its failure represents a significant operational and financial liability.

Unlike conventional control systems that primarily monitor differential pressure across the membrane, the present invention employs multiple sensor arrays 31-38 to capture a comprehensive set of operational parameters including: a. Differential pressure across the membrane (sensors 31, 32) b. Temperature gradients within electrolyte tanks and flow paths (sensors 33, 34) c. Electrolyte conductivity and composition (sensors 35, 36) d. Flow rates and turbulence patterns (sensors 37, 38)

The hybrid neural network architecture at the core of the control system combines LSTM networks for processing time-series data with attention mechanisms that prioritize relevant parameters based on operational context. This approach enables more sophisticated pattern recognition than conventional RNNs by selectively focusing computational resources on the most critical indicators of potential system failure.

The mathematical model governing the control system expands upon traditional approaches by incorporating multiple interrelated parameters:

$$P ( d ) = k ( p ) \cdot V ( d ) - ( α Q ( a ) - β Q ( c ) ) + γ \cdot ( T ( a ) - T ( c ) ) + δ \cdot ( C ( a ) - C ( c ) )$$

Where: a. P₍d₎: Differential pressure across the membrane b. V₍d₎: Potential difference between anolyte and catholyte c. Q₍a₎, Q₍c₎: Anolyte and catholyte flow rates d. T₍a₎, T₍c₎: Anolyte and catholyte temperatures e. C₍a₎, C₍c₎: Anolyte and catholyte conductivity f. k₍p₎, α, β, γ, δ: System-specific coefficients determined through machine learning calibration

The AI controller employs a predictive horizon approach that simultaneously forecasts system behavior across multiple timeframes (1 minute, 10 minutes, 1 hour, 24 hours), enabling both immediate response to developing conditions and strategic optimization for long-term performance.

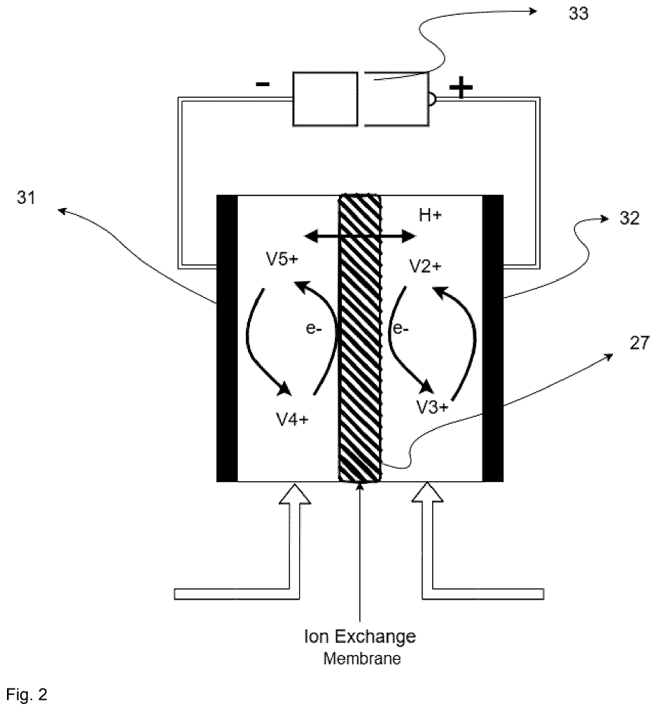

FIG. 2 provides a detailed view of the chemical reactions occurring within the cell stack, illustrating the oxidation-reduction mechanisms and the role of the membrane in ion exchange.

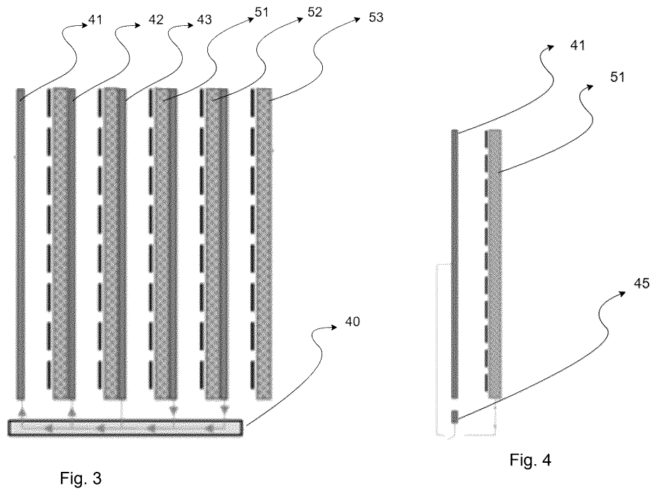

FIG. 3 depicts the cell stack configuration with a comprehensive visualization of electric current flow patterns during both charging and discharging operations.

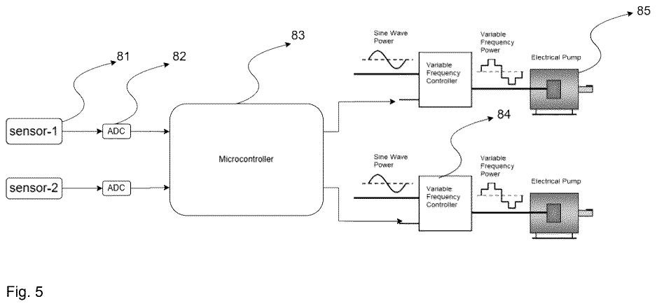

The invention incorporates an adaptive counter electrode system, as shown in FIG. 4, designed to manage zinc dendrite removal during flow battery operation. In contrast to conventional systems that rely on fixed timing cycles, this implementation uses an intelligent control approach to determine the timing and duration of electrode switching events. The schedule is dynamically adjusted based on operational context and inferred system conditions, allowing for more efficient dendrite stripping and improved cell longevity.

The counter electrodes 45 are positioned adjacent to the anodes and are periodically decoupled and reconnected under software control. Rather than adhering to a static interval such as a 10-minute OFF/1-minute ON cycle, the system calculates reversal cycles using a proprietary algorithm informed by internal state variables, performance history, and electrolyte conditions. The specific decision criteria and adjustment logic are retained as trade secrets and are not disclosed in this specification, while the general architecture enables robust and adaptive operation aligned with varying system demands.

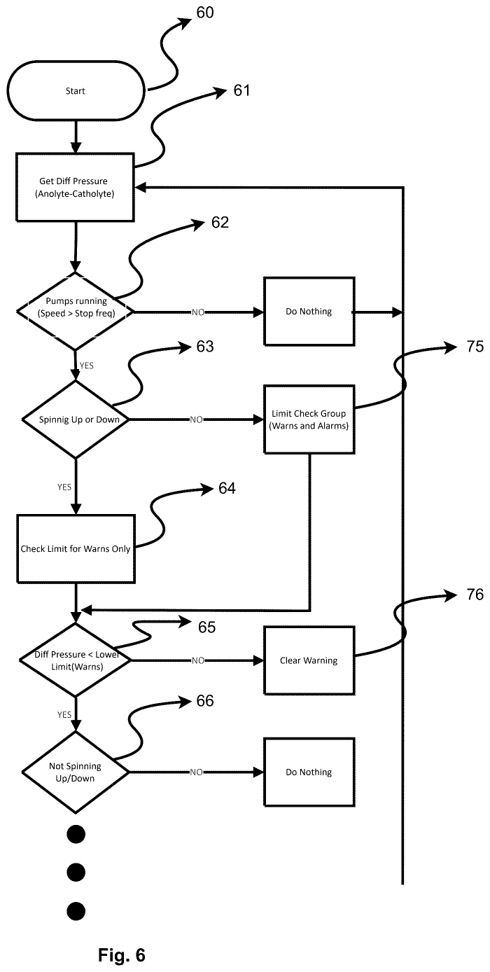

FIG. 5 illustrates the physical architecture of the AI control system, showing the integration of multiple sensor inputs, processing components, and control outputs.

The control system receives inputs from analog pressure sensors 81, temperature sensors 82, conductivity sensors 83, and flow meters 84. These analog signals are converted via dedicated analog-to-digital converters 85 and processed by a high-performance microcontroller 86 running the hybrid neural network algorithm.

The system outputs control signals to variable frequency controllers 87 that regulate pump speeds 88, as well as to valve actuators 89 that can modify flow paths if necessary. The control system also manages counter electrode switching through dedicated relay controllers 90.

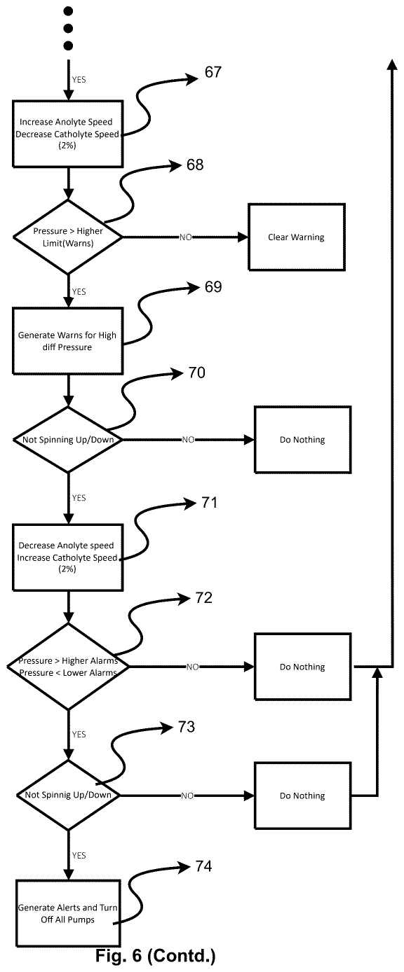

FIG. 6 presents a comprehensive block diagram of the control logic implemented within the AI controller, illustrating the decision pathways and response protocols for various operational conditions.

At system startup (block 60), the controller loads baseline parameters from secure storage and performs an initialization sequence that includes system health verification. The controller then enters its main operational loop, continuously monitoring system parameters (block 61) and processing this data through its predictive models.

Block 62 verifies pump operational status while block 63 identifies the current system state (startup, steady-state operation, or shutdown). Blocks 64-71 implement the hierarchical threshold monitoring and response protocols based on the following operational limits:

TABLE 1
OPERATIONAL THRESHOLDS

| | Warning | Alarm | Warning | Alarm |
|---|---|---|---|---|
| Parameter | Low | Low | High | High |
| Differential Pressure (psi) | 0.4 | 0.1 | 2.0 | 5.0 |
| Temperature Differential | 2.0 | 1.0 | 8.0 | 12.0 |
| (° C.) | | | | |
| Conductivity Ratio | 0.8 | 0.7 | 1.4 | 1.6 |

When parameters approach warning thresholds, the system implements proportional response protocols. For example, if differential pressure approaches the warning low threshold, the controller increases anolyte pump speed by a calculated percentage (typically 1-3%) while decreasing catholyte pump speed by a corresponding amount, with the exact adjustment determined by the predictive model's assessment of system response characteristics.

If parameters reach alarm thresholds (blocks 72, 73), the controller initiates appropriate safety protocols (block 74), which may include controlled system shutdown, emergency electrolyte recirculation, or transition to safe-state operation.

A key innovation of the present invention is its continuous learning capability (block 75), where operational data is analyzed to refine the predictive models and adjust system parameters for optimal performance. This self-optimization occurs during normal operation and enables the system to adapt to changing conditions, component aging, and varying operational demands.

Experimental results demonstrate significant improvements over conventional control systems: a. 37% reduction in membrane failure incidents b. 22% extended membrane lifespan c. 15% increase in overall system efficiency d. 41% reduction in unplanned downtime

Although specific embodiments have been illustrated and described, numerous modifications and variations are possible without departing from the essential characteristics of the invention. The scope of the invention is indicated by the appended claims rather than by the foregoing description.

1. A flow battery system comprising: a. an anolyte tank and a catholyte tank, each containing electrolytes; b. flow channels connecting said tanks to a cell stack containing an ion-exchange membrane; c. variable frequency drive (VFD) controlled pumps that circulate said electrolytes through said flow channels; and d. an AI-based controller that monitors multiple system parameters and adjusts said VFD-controlled pumps to maintain system stability and prevent membrane failure.

2. The flow battery system of claim [0001], wherein said AI-based controller incorporates a hybrid neural network architecture combining Long Short-Term Memory (LSTM) networks with attention mechanisms to predict system behavior across multiple time horizons.

3. The flow battery system of claims [0001] and [0002], wherein said AI-based controller simultaneously monitors differential pressure, temperature gradients, electrolyte conductivity, and flow rates to maintain optimal operating conditions.

4. The flow battery system of any one of claims [0001] to [0003], wherein said AI-based controller employs a mathematical model that calculates differential pressure as a function of potential difference, flow rates, temperature differentials, and electrolyte conductivity.

5. The flow battery system of any one of claims [0001] to [0004], further comprising multiple sensor arrays positioned throughout the system to continuously transmit operational data to said AI-based controller.

6. The flow battery system of any one of claims [0001] to [0005], wherein said AI-based controller implements a hierarchical decision framework with warning and alarm thresholds for each monitored parameter.

7. The flow battery system of any one of claims [0001] to [0006], further comprising a self-learning module that continuously refines operational parameters based on historical performance data and evolving battery conditions.

8. The flow battery system of any one of claims [0001] to [0007], further comprising a cell stack containing multiple electrochemical cells to increase current capacity and energy output.

9. The flow battery system of any one of claims [0001] to [0008], further comprising counter electrodes configured to strip zinc dendrites from anode surfaces during dynamically scheduled reversal cycles.

10. The flow battery system of claim [0009], wherein said AI-based controller dynamically determines optimal timing and duration of said reversal cycles based on predicted dendrite formation patterns rather than fixed timing cycles.

11. The flow battery system of any one of claims [0001] to [0010], wherein said AI-based controller predicts system behavior across multiple timeframes simultaneously to enable both immediate response to developing conditions and strategic optimization for long-term performance.

12. The flow battery system of any one of claims [0001] to [0011], wherein said AI-based controller implements proportional response protocols when parameters approach warning thresholds, with adjustment magnitudes determined by predictive models of system response characteristics.

13. The flow battery system of any one of claims [0001] to [0012], wherein said AI-based controller initiates appropriate safety protocols when parameters reach alarm thresholds, including controlled system shutdown, emergency electrolyte recirculation, or transition to safe-state operation.

14. The flow battery system of any one of claims [0001] to [0013], wherein said ion-exchange membrane is metallic and said AI-based controller maintains differential pressure across said membrane within specified safety limits to prevent membrane breach.

15. A method for controlling a flow battery system, comprising: a. continuously monitoring multiple operational parameters including differential pressure, temperature gradients, electrolyte conductivity, and flow rates; b. processing said parameters through a hybrid neural network architecture to predict system behavior across multiple time horizons; c. implementing adaptive control strategies for variable frequency drives based on said predictions; and d. dynamically adjusting operational parameters to optimize performance while preventing membrane failure.
